(19) United States
(12) Patent Application Publication
(10) Pub. No.: US 2014/0120743 A1
(43) Pub. Date: May 1, 2014

(54) WIRE FOR SLIDING CONTACTS, AND SLIDING CONTACTS

(71) Applicants: Reinhold Weiland, Hanau (DE); Thomas Hild, Hanau (DE); Patrick Baake, Hanau (DE); Harald Manhardt, Hanau (DE); Bernd Gehlert, Bruchkobel (DE)

(72) Inventors: Reinhold Weiland, Hanau (DE); Thomas Hild, Hanau (DE); Patrick Baake, Hanau (DE); Harald Manhardt, Hanau (DE); Bernd Gehlert, Bruchkobel (DE)

(73) Assignee: HERAEUS MATERIALS TECHNOLOGY GMBH & CO. KG, Hanau (DE)

(21) Appl. No.: 14/126,080

(22) PCT Filed: Jun. 12, 2012
(86) PCT No.: PCT/EP2012/002478

§ 371 Date: Dec. 13, 2013

(30) Foreign Application Priority Data
Jun. 15, 2011 (DE) 10 2011 106 518.4

(51) Int. Cl. H01B 1/02; H01R 39/20

(52) U.S. Cl. CPC H01B 1/026; H01R 39/20
USPC 439/28; 174/126.2

(57) ABSTRACT

A wire is provided for producing a sliding contact, wherein at least an inner core of the wire consists of a copper-silver alloy. A sliding contact is also provided having at least one such wire, wherein a counter-contact is provided whose conductive surface has at least one of the wires touch against it. The spring force of the wire acting on the conductive surface of the counter-contact effects electrical contacting between the wire and the counter-contact and the counter-contact is mobile with respect to the wire, such that the surface of the wire slides over the counter-contact when the counter-contact moves. Components having the sliding contact are also provided, including a potentiometric sensor, potentiometer, sliding dolly regulator, position sensor, rotary switch, electrical motor, generator, wind turbine, slip ring system, actuator, or current collector.

### CROSS-REFERENCE TO RELATED APPLICATIONS

This application is a Section 371 of International Application No. PCT/EP2012/002478, filed Jun. 12, 2012, which was published in the German language on Dec. 20, 2012, under International Publication No. WO 2012/171632 A1, and the disclosure of which is incorporated herein by reference.

### BACKGROUND OF THE INVENTION

The invention relates to a wire for producing a sliding contact. The invention also relates to a sliding contact having the wire.

Lastly, the invention relates to a potentiometric sensor, potentiometer, sliding dolly regulator, position sensor, rotary switch, electrical motor, generator, wind turbine, slip ring system, actuator, or current collector having the sliding contact.

There are numerous applications for sliding contacts and wires for sliding contacts, in which electrical current needs to be transmitted to moving parts. Jacketed wires having an internal core made of a first metal and/or a first metallic alloy and a jacket or a coating made of a second metal or a second metallic alloy are used in this context. The jacketed wires are used, for example, as sliding contacts in slip ring transmission systems. These serve for transmission of signal and power currents in rotating systems as, for example, wind power plants or robot arms.

Sliding contacts are known, for example, from German published patent application 4,020,700 A1. German published patent application DE 199 13 246 A1 discloses a wiper slider for transmission of electrical signals, which is designed as a multi-wire wiper contact. The purpose of the multitude of contacts is to ensure that electrical contacting is provided throughout. From European patent application Publication EP 0 054 380 A2 is known a multiple-spring wire contact having a slip ring as sliding contact that consists of a multitude of individual wires. The tendency in slip ring systems is towards the transmission of higher currents. Simultaneously, reduction of expensive noble metals is sought.

A sliding contact having a main body made of a wire, in which a sliding contact body is arranged on one end of the wire is known from German published patent application DE 10 2004 028 838 A1. By this means, it is feasible to select an inexpensive, resilient material for the main body of the contact as, for example, stainless steel, whereas the energy-transmitting part, as a sliding contact body, can consist of another material that is optimized for energy transmission. It is advantageous in this context that expensive noble metal can be saved, since not all of the spring contact needs to be fabricated from a noble metal or a noble metal alloy. A disadvantage of this set-up is that the effort involved in producing the sliding contact is higher as compared to the use of a simple wire.

Copper-beryllium alloys, in particular CuBe₂, which are used widely due to their good elastic properties, are a preferred material for making wires for sliding contacts. It is known to also use, for this purpose, jacketed wires which comprise a core made of a copper-beryllium alloy and a jacket made of a noble metal or a noble metal alloy. The jacketed wires do not possess good resilient properties due to the hardened CuBe₂ core. Moreover, the contact resistance and corrosion resistance of the jacketed wires are typically very good since the jacket usually contains a high fraction of gold.

As a disadvantage, the copper-beryllium alloy possesses poor electrical conductivity as compared to pure copper. Accordingly, the current-carrying capacity of a wire of this type or of a jacketed wire having a core made of a copper-beryllium alloy is comparatively low. In order to conduct higher currents, either the diameters of the wires or the number of wires needs to be increased. Both measures are associated with significant additional costs due to the use of more noble metal in the jacket or coating. Beryllium and beryllium alloys, such as CuBe₂, are being eschewed to an increasing degree due to their detrimental environmental impact.

### BRIEF SUMMARY OF THE INVENTION

Accordingly, it is the object of the invention to overcome the disadvantages of the prior art. In particular, the invention is to provide a wire and a sliding contact having the wire that possesses higher conductivity, but simultaneously still has sufficiently good elastic properties as required for a sliding contact. It would be particularly preferred in this context if this were a wire in which the environment-damaging beryllium is omitted. Moreover, it would be advantageous if the manufacturing costs of the wire, and thus of a sliding contact designed to include the wire, could be reduced.

The object of the invention is met in that at least an inner core of the wire consists of a copper-silver alloy.

Due to its electrical and mechanical properties, the copper-silver alloy allows a thin spring contact with good conductivity to be designed. In this context, the invention can provide the inner core to extend along the entire length of the wire.

The invention can also provide the wire to be an elastic wire having a round or angular cross-section. Wires are easy to obtain. If the wire has a round cross-section, the wire possesses symmetrical elasticity such that a counter-contact of a sliding contact made up of the wire can just as well be uneven.

Particularly advantageous wires according to the invention are characterized in that the copper-silver alloy contains up to 30% by weight silver, preferably 1 to 25% by weight silver, more preferably 5 to 15% by weight silver, and particularly preferably 10% by weight silver.

The mechanical and electrical properties of the mixtures are particularly well-suited for making wires according to the invention. This concerns, in particular, the electrical conductivity of the copper-silver alloy (Cu—Ag alloy) and the elastic properties, i.e. mainly the modulus of elasticity of the Cu—Ag alloy. The wires are then particularly well-suited for sliding contacts according to the invention. The fraction of silver is specified in percent by weight (% by weight) in this context.

The invention can just as well provide the copper-silver alloy to contain small admixtures of other elements with their fraction being less than 4% by weight, in particular Zr and/or Cr, preferably with their fraction being less than 1% by weight, particularly preferably with their fraction being less than 0.1% by weight.

Admixing a small amount of chromium (Cr) or zirconium (Zr) can, for example, simplify the application of a gold alloy as a coating and/or ensure that a gold alloy is more durable on the surface of the wire.

According to another embodiment, the invention can provide the wire to be elongated in extension and to have a cross-section between 0.1 mm and 4 mm. The invention can also provide the thickness of the wire to be from 0.1 mm to 3 mm, preferably the thickness to be from 0.15 mm to 2 mm.

According to another embodiment, the invention can provide the wire to be a reeled-up continuous wire or its length to be 10 mm to 300 mm, preferably its length to be 20 mm to 180 mm, particularly preferably its length to be 30 mm to 100 mm.

Wires of a length between 10 mm and 300 mm are particularly easy to integrate into sliding contacts according to the invention. Providing wires of suitable length dispenses with the need for manual cutting of a continuous wire. Pre-cut wires are therefore particularly preferred for sliding contacts.

According to a particularly preferred embodiment, the invention provides the wire to comprise a coating made of a noble metal alloy, preferably a coating made of a gold alloy, particularly preferably made of a gold alloy comprising silver, copper and/or palladium, even more particularly preferably made of an alloy containing 70% by weight gold, 20% by weight silver, and 10% by weight copper and/or palladium.

The effect of the coating is that the surface of the wire does not oxidize, and thus the wire is ensured to have a low contact resistance to a counter-contact for an extended period of time. Having the core consist of a copper-silver alloy results in a surprising combination effect, namely that the smaller wire cross-section, due to the better electrical conductivity of the copper-silver core, allows a smaller amount of noble metal to be used for wire coating. This saves costs in the making of the wire. Moreover, the Cu—Ag core can be coated with the specified gold alloys particularly well and easily. The durability of the coating on the Cu—Ag alloy is particularly good, in particular in the case of silver-containing gold alloys.

The invention can just as well provide the coated wire to comprise a chromium-containing intermediate layer between the core and the coating. This improves the durability of the coating on the core even more.

Referring to wires according to the invention having a coating, the invention can provide the coating to be an electroplated coating, preferably of a thickness of 0.1 μm to 20 μm, particularly preferably of a thickness of 0.5 μm to 2 μm.

Alternatively, the invention can provide the coating to be a jacket coating applied mechanically such that the wire is a jacketed wire, preferably of a thickness of 5 μm to 50 μm, particularly preferably of a thickness of 10 μm to 25 μm.

Coated wires can also be wherein the coating is a cylinder jacket that extends around the cylindrical core of the wire.

Moreover, the invention can provide the coating of the wire to be applied to the main body by means of roll cladding, sputtering or electroplating.

Non-coated wires can be characterized according to the invention in that the wire consists of the copper-silver alloy. In this case, the wire is a solid copper-silver wire that is operational without an external coating just as well.

The object of the invention is also met by a sliding contact having at least one such wire, wherein a counter-contact is provided whose conductive surface has at least one of the wires touch against it, wherein the spring force of the wire acting on the conductive surface of the counter-contact effects electrical contacting between the wire and the counter-contact and the counter-contact is mobile with respect to the wire, such that the surface of the wire slides over the counter-contact when the counter-contact moves.

In this context, the invention can provide the counter-contact to be supported as in a bearing, such that it can rotate and at least part of the conductive surface of the counter-contact is rotationally-symmetrical.

Moreover, the invention can provide the sliding contact to be a multi-wire wiper contact having a multitude of wires that are electrically contacted to each other. Multi-wire wiper contacts are particularly well-suited since they tolerate the failure of individual contacts and can adapt well to the profile of a counter-contact.

The invention can just as well provide the sliding contact to be designed appropriately such that at least one of the wires touches, by its coating, against the counter-contact.

The object of the invention is also met by a potentiometric sensor, potentiometer, sliding dolly regulator, position sensor, rotary switch, electrical motor, generator, wind turbine, slip ring system, actuator, or current collector having the sliding contact.

Lastly, the object of the invention is also met by a potentiometric sensor, a potentiometer, a sliding dolly regulator, a position sensor, a rotary switch, an electrical motor, a generator, a wind turbine, a slip ring system, an actuator or a current collector having the wire as sliding contact.

The wires and sliding contacts according to the invention can be used particularly effectively in components of this type.

The invention is based on the surprising finding that the material that is used, namely the copper-silver alloy, is a highly conductive material that permits transmission of higher currents at unchanged cross-section or the transmission of unchanged currents through smaller cross-section, and that the alloy concurrently possesses suitable mechanical properties, such as elasticity, to form a spring contact.

If the wire is designed as a jacketed wire or coated wire comprising a core made of the copper-silver alloy, the cross-section being unchanged for higher currents and/or the cross-section being smaller for unchanged currents results in a surprising combination advantage, namely that the jacket or coating, which is usually made of expensive noble metals, has a smaller cross-section and therefore less of the expensive jacket material and/or coating material needs to be used for producing the jacketed wire and/or coated wire. This leads to marked cost reduction in the production of the jacket material and/or coated wire, in particular if the coating is of substantial thickness, as is the case with jacketed wires. Accordingly, this is associated with corresponding savings in noble metal, especially in the case of a jacketed wire.

Based on the much higher electrical conductivity of Cu—Ag materials as compared to CuBe₂, the use of a wire made of a copper-silver alloy, or of a coated wire or a jacketed wire having a Cu—Ag core, enables significantly higher electrical currents to be transmitted at unchanged wire cross-section. In turn, comparable currents can be transmitted with a wire having a smaller cross-section.

Replacing CuBe₂ by Cu—Ag for wires for sliding contacts is a means of meeting the market demand for beryllium-free products. Beryllium is suspected of having detrimental environmental effects, which is the basis of the need for beryllium-free products.

Cu—Ag-based wires according to the invention can be used in sliding contacts according to the invention, such as slip ring transmission systems. The slip ring transmission units are mainly used for transmission of electrical signals and electrical power in wind power plants. In general, slip ring transmission units are used wherever electrical currents are to be transmitted between rotating and static parts, such as is the case, for example, in robot arms.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic side view of a sliding contact according to an embodiment of the invention;

FIG. 2 is a schematic perspective view of a wire according to an embodiment of the invention; and

FIG. 3 is a schematic view of an alternative sliding contact according to an embodiment of the invention.

### DETAILED DESCRIPTION OF THE INVENTION

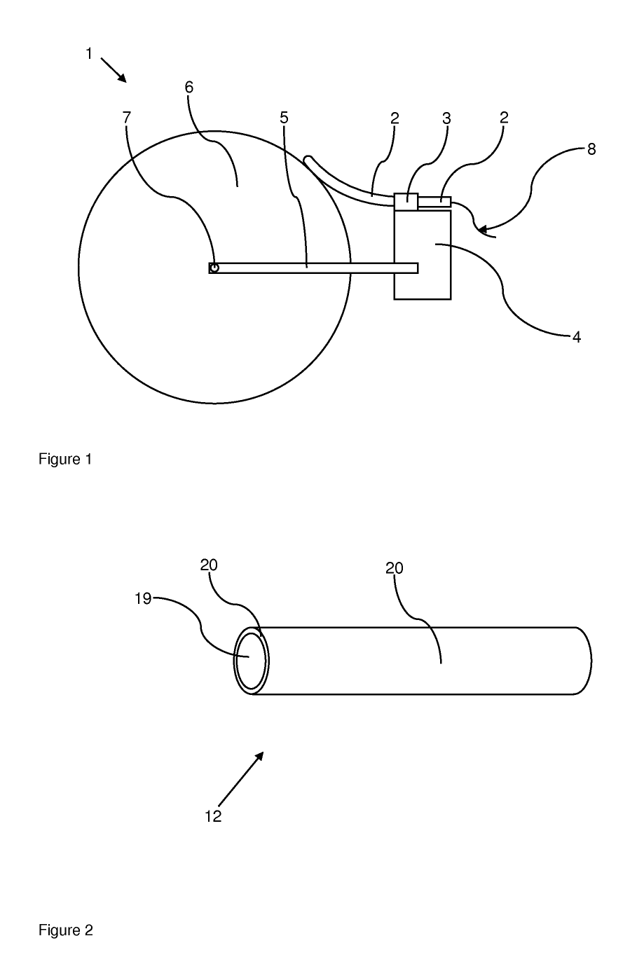

FIG. 1 shows a schematic side view of a sliding contact 1 made up of a wire 2 according to an embodiment of the invention. The wire 2 is either solid and made of a copper-silver alloy or it comprises a core made of the alloy and is coated with a gold alloy on its external jacket surface. The copper-silver alloy conducts electrical current and provides the wire 2 to be sufficiently elastic.

The wire 2 is affixed on a device 4 by means of a fixation 3. The device 4 can be any facility, for example the mast of a wind power plant or a component that is firmly connected to the mast of a wind power plant. Device 4 has a suspension 5 arranged on it that is firmly connected to device 4. A roller 6 as counter-contact of the wire 2 is supported on the suspension 5 as in a bearing, such that it can rotate about an axis 7. For this purpose, the roller 6 has a conductive surface and is cylindrical in shape. The axis 7 doubles as the axis of symmetry of the cylindrical roller 6. The roller 6 is connected via the suspension 5 to the device 4 in non-conductive manner.

The wire 2 is appropriately affixed with respect to the roller 6 such that it is being pressed onto the roller 6. This causes the wire 2 to be elastically deformed. When the roller 6 rotates on the suspension 5, the jacket surface of the wire 2 wipes over the conductive cylinder jacket of the roller 6. The steady contact generated by the wire 2 and the rotating roller 6 allows current to be transmitted from the wire 2 to the roller 6 or vice versa. The spring force of the wire 2 maintains the contacting to the surface of the roller 6.

The wire 2 has an electrical cable 8 attached to it that can be used to conduct current to further components (not shown) or from other components to the wire 2.

Having a core made of a copper-silver alloy or being fully made of a copper-silver alloy, the wire 2 can be designed to have a smaller diameter than conventional wires for conventional sliding contacts for transmitting the same current. The wire 2 is therefore less expensive to manufacture and utilizes fewer resources. The wire 2 can be produced easily, and disposal or reprocessing pose no difficulty. Lastly, the wire 2 fully dispenses with beryllium, which meets more recent environmental requirements.

A wire of the kind shown in FIG. 2 and described in the following can be used as wire 2.

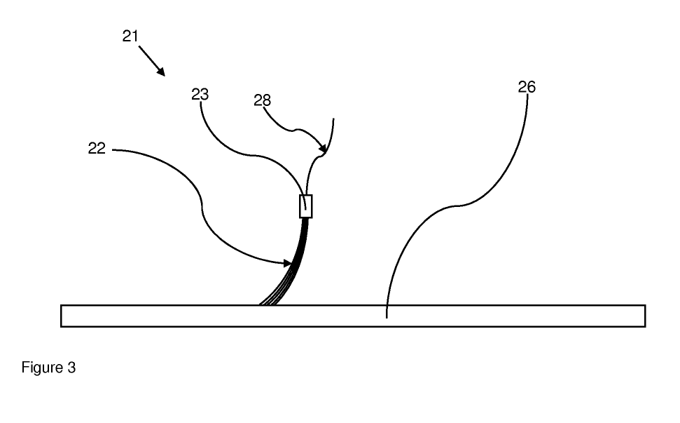

FIG. 2 shows a schematic perspective view of a wire 12 according to the invention for sliding contacts as are shown, for example, in FIGS. 1 and 3. The wire 12 shown is a jacketed wire 12 having a core 19 made of a copper-silver alloy. The jacketed wire 12 has a round cross-section. The round surface of the core 19 is surrounded by a jacket 20 that forms a cylindrical coating of the core 19. The jacket 20 consists of a gold alloy that consists of more than 50% by weight gold. The jacket 20 is applied to the core 19 by mechanical means. Alternatively, the wire 12 can just as well be coated by a thin layer made of the gold alloy.

The coating 20 can be applied to the copper-silver core 19 of the wire 12 by roll cladding, sputtering or electroplating. In order to attain better durability of the coating 20 on the core 19 of the wire 12, an intermediate layer (not shown) can be provided to be situated between the core 19 and the coating 20. The intermediate layer can be, for example, a chromium alloy that is applied onto the core 19 by electroplating or gas phase deposition.

FIG. 3 shows a schematic view of an alternative sliding contact 21 according to the invention. The sliding contact 21 is made up of a multitude of wires 22 according to the invention and thus forms a multi-wire wiper system or a multiple-spring wire contact. The wires 22 are supported by a fixation 23. The fixation 23 positions the wires 22 appropriately such that they are bracketed at a distance from a metallic rail 26, wherein the distance is smaller than the part of the length of the wires 22 that projects from the fixation 23.

This causes the wires 22 to be pressed onto the metallic rail 26 and to be deformed elastically in the process. The spring force of the wires 22 keeps the wires steadily pressed onto the rail 26, which forms the counter-contact for the wires 22. A cable 28 effects electrical contacting of the wires 22 of the sliding contact 21. A current can be transmitted from the rail 26 via the wires 22. When the wires 22 move over the rail 26, current can be transmitted continuously from the rail 26 to the wires 22.

The wires 22 comprise a copper-silver alloy and can therefore be designed to be smaller than wires for conventional sliding contacts. This not only consumes less material, but also allows smaller structures to be implemented. This is advantageous given the steadily progressing miniaturization of many components. The sliding contact 21 shown can be implemented, for example, in a model railway, such as is shown in FIG. 3.

Specifically, wires as shown in FIG. 2 and explained in the pertinent description can be used as wires 22.

It has been evident that copper-silver alloys containing up to 25% by weight silver and the remainder being copper are particularly well-suited for making a wire 2, 12, 22 according to the invention for a sliding contact 1, 21 according to the invention. Moreover, minor admixtures (less than 4% by weight) of other metals can be present in the alloy. For example, chromium or zirconium can be suitable minor admixtures.

The features of the invention disclosed in the preceding description and in the claims, figures, and exemplary embodiments, can be essential for the implementation of the various embodiments of the invention both alone and in any combination.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-16. (canceled)

17. A wire for producing a sliding contact, comprising at least an inner core of the wire consisting of a copper-silver alloy.

18. The wire according to claim 17, wherein the inner core extends along an entire length of the wire.

19. The wire according to claim 17, wherein the copper-silver alloy contains up to 30% by weight silver.

20. The wire according to claim 17, wherein the copper-silver alloy contains small admixtures of other elements with their fraction being less than 4% by weight.

21. The wire according to claim 20, wherein the copper-silver alloy contains Zr and/or Cr with their fraction being less than 1% by weight, optionally less than 0.1% by weight.

22. The wire according to claim 17, wherein a thickness of the wire is from 0.1 mm to 3 mm.

23. The wire according to claim 17, wherein the wire is a reeled-up continuous wire or its length is 10 mm to 300 mm.

24. The wire according to claim 17, wherein the wire comprises a coating made of a noble metal alloy.

25. The wire according to claim 24, wherein the coating is made of a gold alloy.

26. The wire according to claim 25, wherein the gold alloy comprises silver, copper and/or palladium.

27. The wire according to claim 24, wherein the coating is an electroplated coating, optionally having a thickness of 0.1 μm to 20 μm.

28. The wire according to claim 24, wherein the coating is a jacket coating applied mechanically, such that the wire is a jacketed wire, optionally having a thickness of 5 μm to 50 μm.

29. The wire according to claim 24, wherein the coating is a cylinder jacket that extends around a cylindrical core of the wire.

30. The wire according to claim 17, wherein the wire consists of the copper-silver alloy.

31. A sliding contact comprising at least one wire according to claim 17, a counter-contact whose conductive surface has at least one of the wires touch against it, wherein a spring force of the wire acts on the conductive surface of the counter-contact to effect electrical contacting between the wire and the counter-contact, and wherein the counter-contact is mobile with respect to the wire, such that a surface of the wire slides over the counter-contact when the counter-contact moves.

32. The sliding contact according to claim 31, wherein the counter-contact is supported against the wire as in a bearing, such that it can rotate and at least part of the conductive surface of the counter-contact is rotationally-symmetrical.

33. The sliding contact according to claim 31, wherein the sliding contact is a multi-wire wiper contact having a multitude of wires that are electrically contacted to each other.

34. The sliding contact according to claim 31, having at least one wire comprising an inner core consisting of a copper-silver alloy and a coating made of a gold alloy, wherein the sliding contact is designed such that the coating of at least one of the wires touches against the counter-contact.

35. An electrical component having a sliding contact according to claim 31, wherein the component is at least one of a potentiometric sensor, a potentiometer, a sliding dolly, a regulator, a position sensor, a rotary switch, an electrical motor, a generator, a wind turbine, a slip ring system, an actuator, and a current collector.
